(19) United States
(12) Patent Application Publication
(10) Pub. No.: US 2009/0285530 A1
(43) Pub. Date: Nov. 19, 2009

(54) SLEEVE AND OPTICAL CONNECTOR USING THE SAME

(75) Inventors: WU-KUANG CHEN, Tu-Cheng (TW); XIAO-SHE BIAN, Shenzhen City (CN); ZHI-AN GAN, Shenzhen City (CN); HONG-ZE JIA, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/197,318

(22) Filed: Aug. 25, 2008

(30) Foreign Application Priority Data
May 19, 2008 (CN) 200810301622.2

(51) Int. Cl. G02B 6/26

(52) U.S. Cl. 385/39

(57) ABSTRACT

An exemplary sleeve used for an optical fiber connector includes a tubular main body. The main body is made of ceramic material. A cylindrical wall of the main body defines a cutout.

### BACKGROUND OF THE INVENTION

1. Field of the Invention

The present invention relates a sleeve and an optical connector using the same.

2. Description of the Related Art

Referring to FIG. 3, a related-art optical connector 100 is shown. The optical connector 100 includes a sleeve 10, a housing 12, and an optical medium 14.

Also referring to FIG. 4, the sleeve 10 includes a tubular main body 101. The main body 101 defines a cylindrical cavity 103.

The housing 12 defines a receiving hole 123. The optical medium 14 includes a cylindrical ferrule 141 and an optical fiber 143 received in the ferrule 141. An outer diameter of the ferrule 141 substantially equals to an inner diameter of the main body 101 of the sleeve 10. One end of the optical medium 14 fixed on the housing 12 and the other end of the optical medium 14 is received in the receiving hole 123. The sleeve 10 is sleeved on the optical medium 14 and is also received in the receiving hole 123.

In use, an optical medium 18 of an optical fiber connector is inserted into the cavity 103 of the sleeve 10 such that an end of the optical medium 18 resists an end of the optical medium 14. Then, optical signals can be transmitted between the optical fiber 183 and the optical fiber 143.

However, because the inner diameter of the cavity 103 substantially equals to the outer diameter of the ferrule 181, when the optical medium 18 is inserted into the cavity 103 of the sleeve 10, the outer surface of the ferrule 181 is tightly confined in the inner surface of the sleeve 10, thus, air in the cavity 103 becomes trapped in the space defined by the sleeve 10, the optical medium 14, and the optical medium 18. As a result, when optical signals pass through the air layer, some of the optical signals undergo total reflection due to the air and particles in the air. In addition, the air layer and particles blended in the air layer may absorb a certain amount of the optical signals. As a result, the optical connector has a high optical signal loss.

Therefore, a new optical connector is desired in order to overcome the above-described shortcoming.

### SUMMARY

A sleeve used for an optical connector includes a tubular main body. The main body is made of ceramic material. A cylindrical wall of the main body defines a cut-out.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical connector. Moreover, in the drawings, like reference numerals designate corresponding parts throughout several views, and all the views are schematic.

FIG. 1 is a cross-sectional view of one embodiment of an optical connector.

FIG. 2 is an isometric view of the sleeve of the optical connector in FIG. 1.

FIG. 3 is a cross-sectional view of a related-art optical connector.

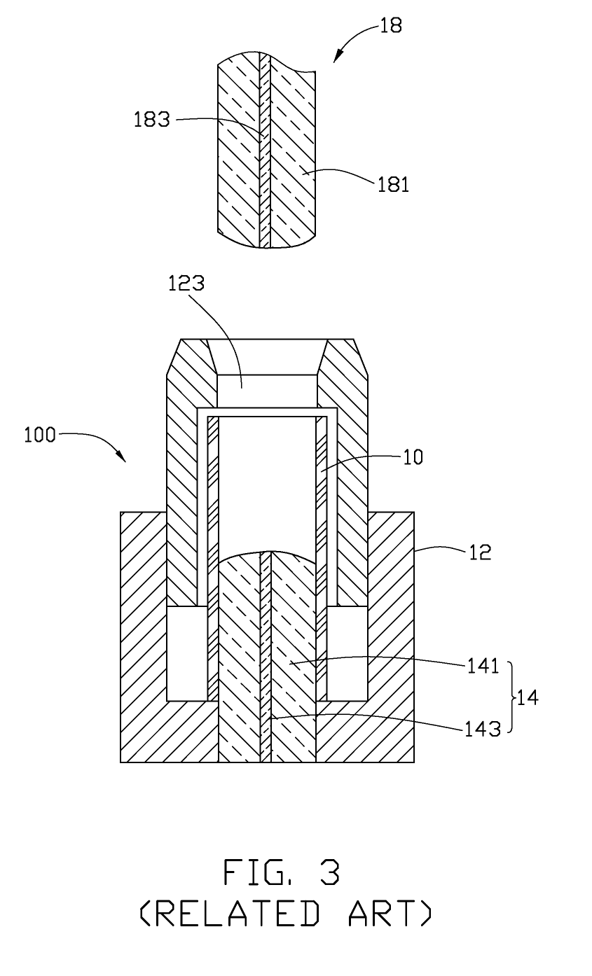

FIG. 4 is an isometric view of the sleeve of the optical connector in FIG. 3.

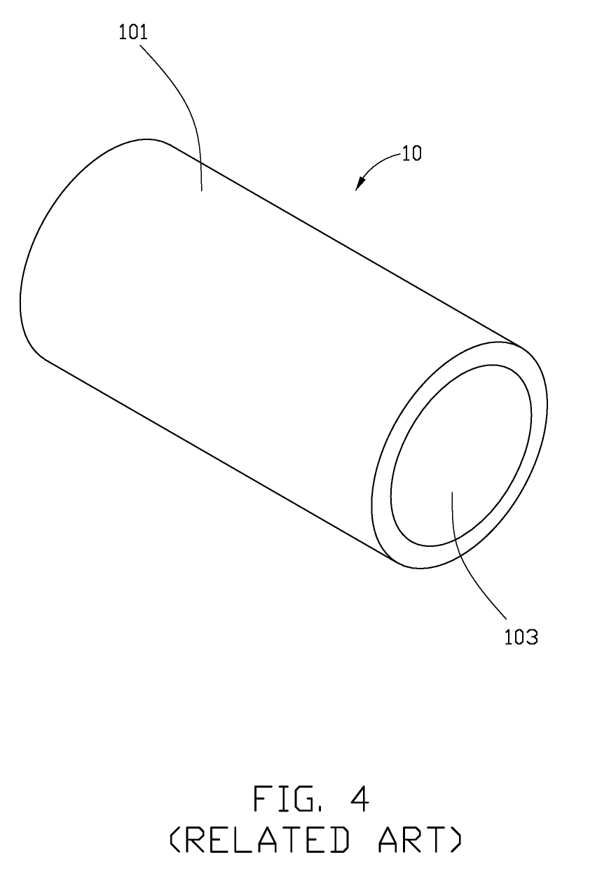

### DETAILED DESCRIPTION OF THE EMBODIMENT

Reference will now be made to the drawings to describe an exemplary embodiment of the present sleeve and optical connector using the same in detail.

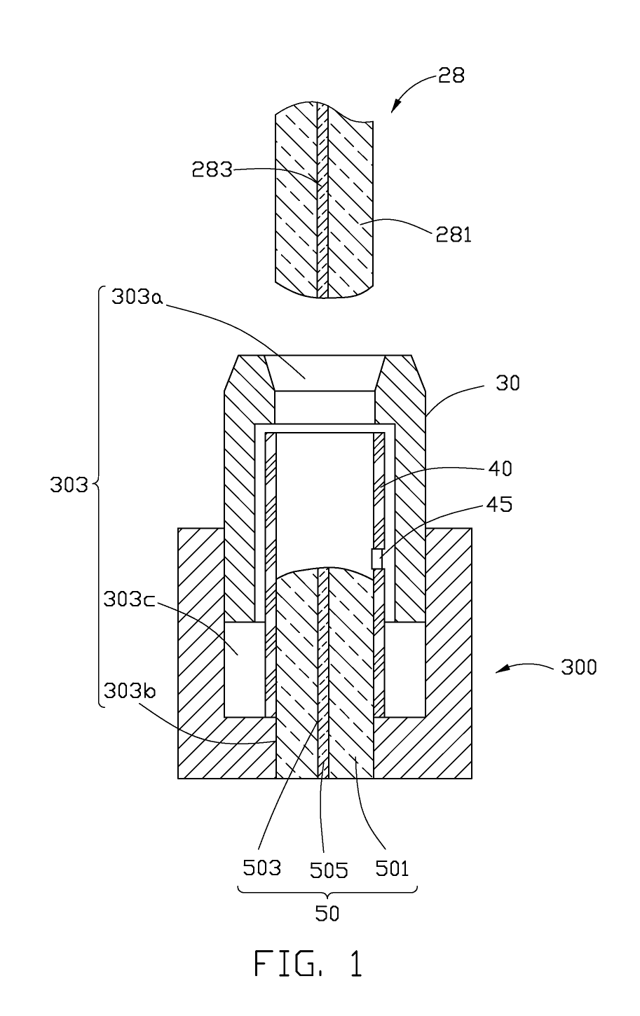

Referring to FIG. 1, an optical connector 300 includes a housing 30, a sleeve 40, and an optical medium 50.

The housing 30 defines a through hole 303. The through hole 303 includes a receptacle end 303a, a stem end 303b, and a buffer portion 303c between the receptacle end 303a and the stem end 303b.

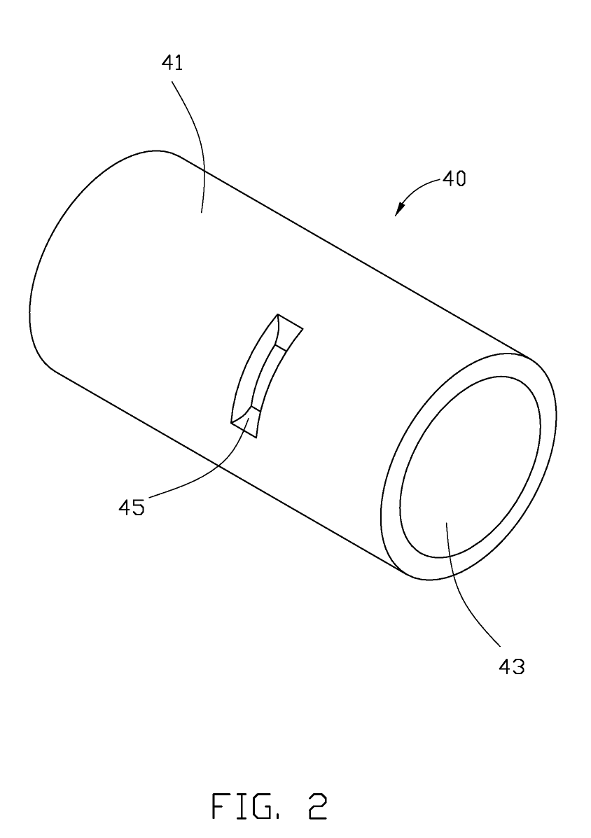

Also referring to FIG. 2, the sleeve 40 includes a tubular main body 41. The main body 41 defines a cavity 43 and a cutout 45. A shape of the cross-section of the main body 41 taken along a plane perpendicular to a longitudinal direction of the main body 41 is annular. The cutout 45 is defined in a middle portion of a cylindrical wall of the main body 41. The cutout 45 communicates with the cavity 43. In the illustrated embodiment, the length of the sleeve 40 is in the range from about 3 millimeters to about 8 millimeters. The thickness of the cylindrical wall of the main body 41 is in the range from about 0.15 millimeters to about 0.7 millimeters.

The optical medium 50 includes a cylindrical ferrule 501 and an optical fiber 505. The ferrule 501 defines a through hole 503. The optical fiber 505 is received in the through hole 503. The sleeve 40 is inserted into the buffer portion 303c. The optical medium 50 partially protrudes into the sleeve 40 in a way such that the tip of the optical medium 50 protruding in the buffer portion 303c is substantially aligned with the cutout 45 and another portion of the ferrule 501 away the tip is attached to the housing 30. In other word, a portion of the first optical medium 50 is fixed on the second end 303b and the other end of the optical medium 50 extends into the central portion 303c within the sleeve 40. The sleeve 40 is received in the through hole 303. A lower half of the optical medium 50 is sleeved on the optical medium 50 in such manner that the one end of the optical medium 50 is adjacent to, but does not block, the cutout 45.

A method of making the sleeve 40 includes the following steps: firstly, a tubular main body is formed by injection molding with ceramic materials such as zirconia (ZrO₂). Then, intering, abrasing, and polishing processes are performed on the main body in that order. Finally, a cutout 45 is defined in the cylindrical wall of the main body by a grinding wheel, thereby yielding the sleeve 40 shown in FIG. 2.

To prevent the ferrule 501 displacement in the cavity 43, the inner diameter of the sleeve 40 substantially equals to the outer diameter of the ferrule 501. In addition, the thickness of the grinding wheel is in the range from 0.1 millimeters to 2 millimeters, as a result, the minimum width of the cutout 45 is in the range from 0.1 millimeters to 2 millimeters. Because the cutout 45 is relatively small, the cutout 45 does not weaken the structural strength of the sleeve 40.

In use, an optical medium 28 is inserted into the cavity 43 of the sleeve 40 from the receptacle end 303a. When the optical medium 28 moves towards the optical medium 50, air in the cavity 43 is expelled out of the cutout 45. As a result, air and particles between the end of the optical medium 28 and the end of the optical medium 50 is totally or mostly eliminated. Since there is not air layer and particles blended in the air layer that separates the end of the optical medium 28 from the end of the optical medium 50. optical signals can be transmitted between the optical fiber 505 and the optical fiber 283 directly with less reflections and absorptions. Therefore, optical signal loss is reduced.

Finally, while various embodiments have been described and illustrated, the invention is not to be construed as being limited thereto. Various modifications can be made to the embodiments by those skilled in the art without departing from the true spirit and scope of the invention as defined by the appended claims.

1. A sleeve used for an optical connector, comprising:
a tubular main body, wherein the main body is made of ceramic material, and a cylindrical wall of the main body defines a cavity for receiving two optical media and a cutout communicated with the cavity, the cutout is enclosed and positioned in or adjacent to a middle portion of the cylindrical wall along a longitudinal direction thereof.

2. (canceled)

3. The sleeve as claimed in claim 1, wherein a minimum width of the cutout is in the range from about 0.1 millimeters to about 2 millimeters.

4. The sleeve as claimed in claim 1, wherein a cross-section of the main body taken along a plane perpendicular to a longitudinal direction thereof is annular.

5. The sleeve as claimed in claim 1, wherein a thickness of the cylindrical wall of the main body is in the range from about 0.15 millimeters to about 0.7 millimeters.

6. The sleeve as claimed in claim 1, wherein a length of the main body is in the range from about 3 millimeters to about 8 millimeters.

7. The sleeve as claimed in claim 1, wherein the ceramic material is zirconia.

8. An optical connector comprising:
a housing;
an optical medium; and
a sleeve sleeved on the optical medium, wherein the sleeve includes a tubular main body made of ceramic material, the main body having a cylindrical wall of the main body which defines a cavity for receiving the optical medium and a cutout communicated with the cavity, the cutout is enclosed and positioned in or adjacent to a middle portion of the cylindrical wall along a longitudinal direction thereof, a portion of the optical medium is fixed on the housing and one end of the optical medium is received in the main body, and the end of the optical medium received in the main body is adjacent to, but does not block, the cut-out.

9. (canceled)

10. The optical connector as claimed in claim 8, wherein a minimum width of the cutout is in the range from 0.1 millimeters to 2 millimeters.

11. The optical connector as claimed in claim 8, wherein a cross-section of the main body taken along a plane perpendicular to a longitudinal direction thereof is annular.

12. The optical connector as claimed in claim 8, wherein a thickness of the cylindrical wall of the main body is in the range from about 0.15 millimeters to about 0.7 millimeters.

13. The optical connector as claimed in claim 8, wherein a length of the main body is in the range from about 3 millimeters to about 8 millimeters.

14. The optical connector as claimed in claim 8, wherein the ceramic material is zirconia.
